(19) United States
(12) Patent Application Publication
(10) Pub. No.: US 2024/0180173 A1
(43) Pub. Date: Jun. 6, 2024

(54) PIZZA FOR HOME BAKING WITH A PRETZEL CRUST THAT APPEARS DURING HOME BAKING

(71) Applicant: SOCIETE DES PRODUITS NESTLE S.A., Vevey (CH)

(72) Inventors: SHELDON FERNANDES, Chernex (CH); ERIC GREENSTEIN, Aurora, OH (US); DEBORAH KELLY, Bay Village, OH (US); JIAN LI, Chagrin Falls, OH (US); ANJNA DEVI, Solon, OH (US); FRANCESCO FIERRO, Napoli (IT)

(21) Appl. No.: 18/556,449

(22) PCT Filed: Apr. 25, 2022
(86) PCT No.: PCT/EP2022/060854

§ 371 Date: Oct. 20, 2023

Related U.S. Application Data
(60) Provisional application No. 63/178,856, filed on Apr. 23, 2021.

(51) Int. Cl. A21D 13/24; A21D 13/28; A21D 13/41

(52) U.S. Cl. CPC A21D 13/24; A21D 13/28; A21D 13/41

(57) ABSTRACT

The present invention relates generally to the field of food and nutrition. In particular the present invention relates to a combination of two very popular foods, namely pizza and pretzels. For example, the present invention relates to a prepared pizza with a pretzel crust for home baking. Remarkably, the pretzel-type crust can appear, when the pretzel-pizza is baked at home. One embodiment of the present invention relates to a prepared pizza that is to be subjected to a heating step before consumption comprising a prebaked pizza crust, wherein the prebaked pizza crust is coated at least partially with a lye after prebaking.

The present invention relates generally to the field of food and nutrition. In particular, the present invention relates to a combination of two very popular foods, namely pizza and pretzels. For example, the present invention relates to a prepared pizza with a pretzel crust for home baking. Remarkably, the pretzel-type crust can appear, when the pretzel-pizza is baked at home. One embodiment of the present invention relates to a prepared pizza that is to be subjected to a heating step before consumption comprising a prebaked pizza crust, wherein the prebaked pizza crust is coated at least partially with a lye after prebaking.

Pizza is one of the world's most popular foods today. Modern pizza has its origins likely in Naples, Italy, in the 18th or early 19th century. At that time pizza was usually sold out of pizza bakeries which were often open-air stands. Italian immigrants brought pizza to the United States probably in the late nineteenth century.

Since then, pizza has become very popular worldwide. Several styles of pizza have evolved in different regions of the world, that may differ from the original Italian style pizza. In the United States, for example, very popular are Chicago-style pizza, New York-style pizza, Neapolitan-style pizza, California-style pizza, Greek-style pizza. Detroit-style pizza, Sicilian-style pizza and St. Louis-style pizza.

Originally pizza contained as toppings at least a tomato-based sauce, cheese, and optionally further toppings.

Nowadays, also the crust used in pizza varies, for example, to meet different consumer preferences. Typically, pizzas are classified as thin-crust pizza or thick-crust pizza.

To even further diversify the pizza experience, for example, pizza delivery services in the United States offer continuously or as short-term promotions further variations of the pizza crust. For example, a soft pretzel crust pepperoni pizza was recently offered by Little Ceasars®.

Such a pretzel-type pizza crust was, for example described in DE102011121388. DE102011121388 relates to the combination of pizza and lye pastries. Accordingly, lye is applied to the unbaked pizza dough, and then the “lye pizza” is baked.

However, in particular for frozen pizza that the consumer bakes at home, it would be preferred, if the browning effect that is caused by the lye only appeared when the consumer bakes the pizza. Freezing and selling a completely unbaked pizza is not a preferred option due to shelf-life requirements and safety risks.

Hence, there is a need in the art for a prebaked lye pizza that the consumer finishes by baking it, wherein the typical browning effect caused by the lye appears in the consumer's oven.

It would therefore be desirable to provide the art with a prebaked pizza with a lye crust that can be distributed in a chilled or frozen state and wherein the typically browning and/or taste effect that is caused by the lye occurs when the consumer is heating the prebaked pizza at home.

Any reference to prior art documents in this specification is not to be considered an admission that such prior art is widely known or forms part of the common general knowledge in the field.

The object of the present invention is it to enrich or to improve the state of the art and in particular to provide a prebaked pizza with a lye crust that is to be distributed and to be prepared for consumption by consumers by subjecting the prebaked pizza to a heating step, wherein the typical taste and browning effect caused by the lye appears when the consumer is carrying out the heating step prior to consumption, or to at least provide a useful alternative to solutions existing in the art.

The inventors were surprised to see that the object of the present invention could be achieved by the subject matter of the independent claims. The dependent claims further develop the idea of the present invention.

Accordingly, the present invention provides a prepared pizza that is to be subjected to a heating step before consumption comprising a prebaked pizza crust, wherein the prebaked pizza crust is coated at least partially with a lye after prebaking.

The present invention further provides a process for making a prepared pizza in accordance with the present invention. The subject matter of the present invention also extends to a prepared pizza obtained by or obtainable with the process of the present invention.

As used in this specification, the words “comprises”, “comprising”, and similar words, are not to be interpreted in an exclusive or exhaustive sense. In other words, they are intended to mean “including, but not limited to”.

The present inventors have shown that by applying lye to the prebaked pizza crust it was possible to increase the safety of the product through the pre-baking step. At the same time, applying the lye to at least a part of the prebaked pizza crust allowed it that the typical browning and taste sensation caused by the lye appears when the consumer heats the prebaked pizza in its oven at home.

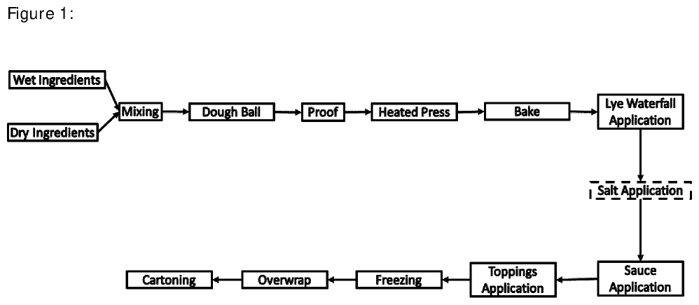

FIG. 1 shows a graphical presentation of the process of the present invention.

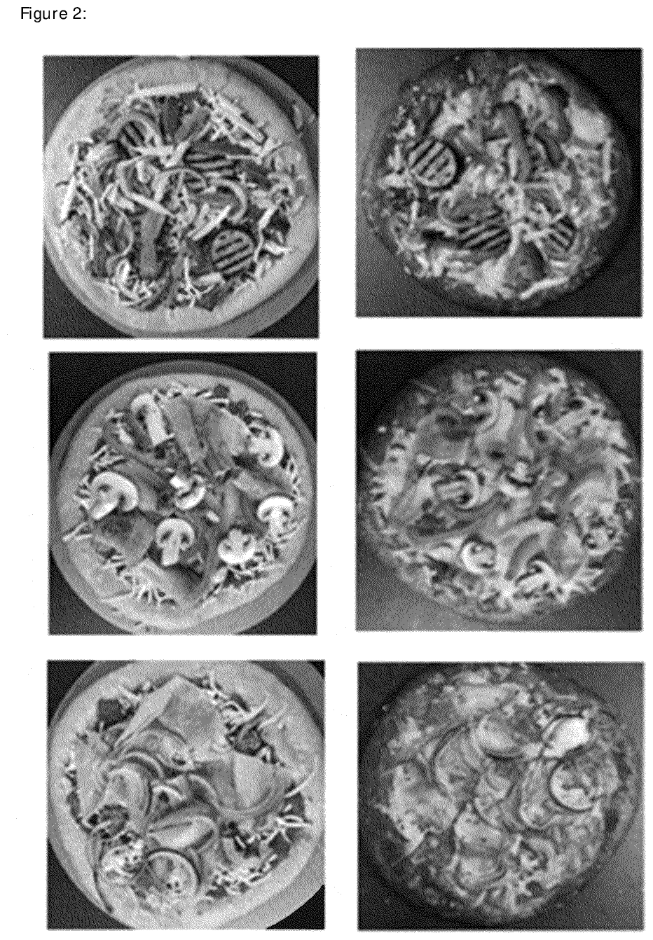

FIG. 2 shows the transformation of the pizza crust in accordance with the present invention when heated in a consumer oven. The figure shows from top to bottom the following varieties: Grilled vegetables and cheese topping, Ham and vegetables, and Ham and onion with cheese.

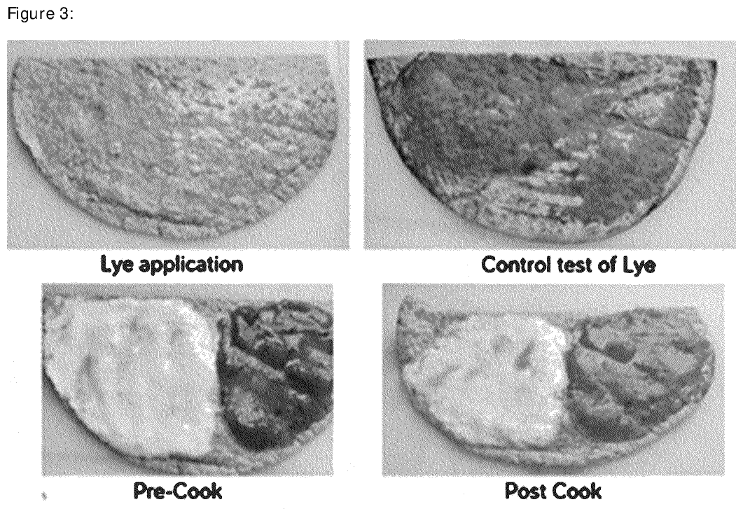

FIG. 3 shows that the application of a lye has no impact on sauce quality.

Consequently, the present invention relates in part to a prepared pizza that is to be subjected to a heating step before consumption comprising a prebaked pizza crust, wherein the prebaked pizza crust is coated at least partially with a lye after prebaking.

For the purpose of the present invention, a pizza shall be considered as “prepared” if it can be made ready for consumption, simply by subjecting the prepared pizza to a heat treatment. For example, a prepared pizza may be characterized in that no further ingredients need to be added to the pizza before consumption.

A pizza for the purpose of the present invention may comprise an essentially flat crust with a rim topped with at least a tomato-based sauce and a cheese. For example, for the purpose of the present invention, the pizza may also be a Calzone-type pizza.

A pizza shall be considered prebaked, if at least the dough that will result in the pizza crust was subjected to baking, even though the baking does not have to result in the pizza crust being completely baked.

For the purpose of the present invention a lye shall be an alkaline solution, for example a strongly alkaline solution, usually made with sodium hydroxide, potassium hydroxide, calcium carbonate, or combinations thereof.

In accordance with the present invention the pizza crust is coated at least partially with a lye after prebaking. For example, only the rim of the pizza crust may be coated with the lye. This has the advantage that there is little or no lye underneath the toppings of the pizza, as the lye could have an unwanted impact on the taste, consistency or color of the toppings.

It is further within the scope of the present invention that the lye is applied to the top of the crust in the form of a pattern, a logo and/or a message. This way the pattern, the logo, and/or the message would seemingly magically appear, when the consumer is baking the prepared pizza at home prior to consumption.

In particular, when the pizza is a calzone-type pizza, there will be a lot of space for patterns, logos and messages on the upper side of the calzone.

The inventors have found that the lye coating imparts a particular taste and texture profile to the pizza crust, in particular the rim of the pizza crust, that helps to elevate the taste experience of the pizza to another level.

The toppings may be applied on top of the pizza dough before pre-baking. However, it is preferred if the toppings are applied on top of the prebaked pizza crust. This has the advantage that the prebaking of the pizza crust will help to prevent that the pizza crust will become soggy from the moisture contained in the added toppings. Also, if the toppings are added fresh to the prebaked pizza and the prepared pizza is then chilled or frozen, the toppings will be perceived as fresher when the prepared pizza is unwrapped before the final baking step. If the toppings of the pizza are subjected to a prebaking step, this may impair their visual appearance somewhat.

Hence, it may be preferred for the purpose of the present invention, if the toppings are applied on top of the prebaked and at least partially lye-coated pizza crust. Any toppings that are typically used for pizza may be used. For example, the toppings may be selected from the group consisting of tomato-based sauce, cheese, pepperoni, salami, mushrooms, onions, sausage, egg, anchovies, artichokes, bacon, olives, peppers, pineapple, spinach, or combinations thereof.

As lye, any lye typically used to manufacture pretzels may be used. For example, a baking soda-based lye, a baking powder-based lye and/or a calcium carbonate-based lye may be used. A NaOH or a KOH based lye may alternatively be used and has the advantage that a beautiful crispy exterior crust will be generated that has a deep mahogany color with a lot of a sheen on the crust; and a pronounced typical pretzel flavor profile. Hence, the lye may be a lye prepared with baking powder, baking soda sodium carbonate, sodium hydroxide, potassium hydroxide, or combinations thereof. The inventors have obtained particular beneficial results when the lye was a sodium hydroxide solution, for example a 3-5 weight-% sodium hydroxide solution in water. In one embodiment of the present invention the lye was an about 4 weight-% sodium hydroxide solution in water.

The lye may be applied to the whole pizza crust, only to the upper surface of the pizza crust, only to the rim of the pizza crust, or to the rim and the bottom of the pizza crust, for example. As indicated before, for some applications it may be preferred if the unbaked lye is not brought into contact with the toppings of the pizza. Consequently, it may be preferred if the lye is applied to the rim of the pizza, but not to the rest of the pizza crust which is covered by toppings.

On typical feature of pretzels is that some coarse salt is sprinkled on top of the lye coated crust. The coarse salt may be added to the packaged pizza, so that the consumer can sprinkle the coarse salt on top of the lye coated pizza crust before the final baking step in an amount that is in accordance with the consumers preference. Consumer research shows that some consumers prefer plenty of coarse salt sprinkles while others prefer very little or none at all. Also, for consumers that wish to consume low amounts of sodium, it may be preferred if the consumer is in control of the amount of course salt sprinkled on top of the lye coated pizza crust.

The coarse salt may also be already added to the surface of the lye coated pizza crust. This has the advantage that no additional salt-sprinkling step is required when the consumer is subjecting the prepared pizza to the final heating step. This eliminates a possible source of unwanted mess in the final preparation of the pizza. Accordingly, for the prepared pizza in accordance with the present invention the coarse salt may be applied to the rim of the prebaked pizza crust on top of the lye coating before subjecting the pizza to the heating step before consumption.

For an optimum appearance of the sprinkled salt on top of the lye coated pizza crust after the final baking step, it may be preferred if it is avoided that the salt sprinkles attract too much moisture due to the salt sprinkles hygroscopic properties. If that happens, the salt sprinkles may partially dissolve, which looks unattractive.

Adding the coarse salt sprinkles just before the final heat treatment will eliminate that risk. However, if it is preferred that the coarse salt is are already sprinkled on top of the lye coated pizza crust when the consumer unpacks the prepared pizza, it may be preferred if a coarse salt is used, that has a reduced risk of attracting moisture. For example, a coated coarse salt may be used. The coating will then help to reduce the risk that a part of the coarse salt is dissolved. For example, such a coarse salt sprinkle may comprise an inner part comprising the salt and an outer coating, wherein said outer coating comprises hydrophobic particles. For example, the outer coating may comprise or consist of a lipid, for example an oil. Hence, for the purpose of the present invention the coarse salt may be, for example an encapsulated coarse salt.

The final heating step before consumption pf the pizza will typically be carried out by the consumer. Usually, the final heating step will be carried out in an oven. Specialized pizza ovens are available for this, but a usual standard oven will also produce very good results. It can be noted here that the final heating step can also be carried out on a grill, for example, in particular, if the grill has a cover.

Generally, the prepared pizza needs to be heated at a temperature and for a time period that is sufficient to finish the baking process of the pizza. A skilled consumer will be able to adjust time and temperature accordingly, so that the produced pizza is to the consumers liking.

For example, the heating step before consumption may be to be carried out at at least 180ºC for at least 15 minutes. Typically, in particular if a crunchy crust is desired, it is preferred if the pizza is baked at a high temperature for a short time. Accordingly, the heating step before consumption may be to be carried out at an oven temperature of at least 220° C. for at least 8 minutes, or at at least 250° C. for at least 5 minutes.

The artisanal way of making a pizza crust typically involves first keeping a raw pizza dough in the form of a ball or loaf, and preferably to let it rest for a certain period of time at room or some elevated temperature in order to let it proof, and then to form or shape the dough ball into a more or less round, thin and flattened dough disk by hand using the fingers and/or other kitchen aid instruments. Thereafter, typically an elevated rim is formed at the edge of the dough disk by hand in order to prevent toppings like e.g., tomato sauce from flowing off the dough crust before or during the baking of the finally topped pizza. The rim, i.e., outer crust, is made elevated also to allow pick up of the pizza slice by hand and provide the experience of the superior crust flavor and texture without the tomato sauce.

Pizza dough comprises at least flour, salt and water. As a raising agent typically sour dough or yeast is used. In one preferred embodiment of the present invention, the raising agent is baker's yeast.

For example, the pizza crust may be made from a dough comprising about 55-70 weight-% flour, about 1-3 weight-% salt, about 1-3 weight-% vegetable oil, baker's yeast and water. The flour is preferably wheat flour.

In a further preferred embodiment of the present invention the pizza crust may be made from a dough comprising about 55-70 weight-% flour, water, about 1 to 3 weight-% salt, and about 0.05 to 2.0% weight-% yeast, and optionally about 0.5 to 5 weight-% vegetable oil, and/or about 0 to 15 weight-% sugar. The vegetable oil may be olive oil, for example. The vegetable oil will contribute to the smoothness and softness of the dough and the inside of the pizza crust after baking. Sugar may serve as a natural taste enhancer, but will also help to stimulate the yeast, so that the dough is proofing perfectly.

After preparation, the prepared pizza will be distributed to the consumer. For this, it is preferred if the prepared pizza is chilled or frozen to guarantee product freshness and safety. Also, to ensure product safety and easy handling during distribution and sales, the prepared pizza may be packaged. Typically, such a prepared pizza in accordance with the present invention may be packaged by overwrapping the pizza in a sealed barrier paper wrap, or a plastic wrap. Additionally, the wrapped pizza may be packaged in pa carton, for example a pizza carton.

The scope of the present invention also extends to a process for making a prepared pizza comprising a prebaked pizza crust, wherein the prebaked pizza crust is coated at least partially with a lye after prebaking, and wherein the prepared pizza is to be subjected to a heating step before consumption.

Accordingly, the present invention also relates to a process for making a prepared pizza in accordance with the present invention comprising the steps of
preparing a dough by mixing the dough ingredients,
forming the dough into at least one dough ball,
proofing the at least one dough ball,
pressing a dough ball into the shape of a preformed pizza crust,
baking the preformed pizza crust,
applying the lye to at least a part of the top of the baked pizza crust, and
applying the toppings on top of the baked pizza crust to which the lye was at least partially applied.

As stated above, the pizza dough comprises at least flour, water and salt. For the purpose of the present invention, it is preferred if the dough comprises flour, water, salt, yeast, vegetable oil and sugar. The ingredients are mixed and kneaded into a dough.

The dough is then formed into a dough ball.

A “dough ball” of the present invention is a portioned part of the dough. It may be a block, lump or chunk of the dough. Preferably it is in a cube-like or a rounded ball or flattened ball-like form, as for example typically formed as approximately a handful of dough.

Preferably, the dough ball used in the process of the present invention is portioned for a regular size or family size pizza product. Preferably, the dough ball is portioned to a wet-weight before use from 100 g to about 600 g, preferably from 150 g to 450 g, more preferably from 200 g to 300 g, per dough ball.

The process comprises a further step of proofing the dough portion before flattening it in the form of a pizza crust in the pressing step. Proofing of the dough may be achieved by letting it sit for a prolonged time at a temperature between about 20° C. and 37° C., before pressing.

For example, it may be preferred if the proofing is carried out at a temperature in the range of about 18° C. to 40° C., for a time in the range of about 30 minutes to 24 hours.

It may further be preferred if the process comprises a further step of applying an oil onto the surface of the dough ball before subjecting it to the pressing step. Preferably, the oil is applied to the surface of the dough ball by spraying. The oil can be applied to the top surface, to the bottom surface or two both surfaces of the dough ball. It has been surprisingly found by the inventors, that applying an oil onto the surface of the dough ball allows a more efficient pressing step. For example, the sticking of the dough to the surfaces of the pressing device is reduced and the time needed for the pressing step in the process of the present invention can be further reduced as well. Also, the surface of the preformed pizza crust tends to be smoother. Preferably, the oil is a vegetable oil.

The pressing may be carried out by any means known in the art. For example, the press may be not heated. As such, the press could operate at ambient temperature. The inventors have obtained very good results using a heated press. A very useful process for the pressing step is described, for example, in WO2021009151A1, herein fully incorporated by reference.

For example, the inventors have obtained very good results, when the pressing was carried out with a heated press operating at a temperature in the range of about 25° ° C. to 220° C., or of about 60 to 220° C.

The heated press may comprise a flat surface onto which the dough ball is placed and a heating plate, which is pressed onto the dough ball on the flat surface to generate the preformed pizza crust.

In one embodiment of the present invention, the heating plate is heated. Preferably, the heating place is heated to a temperature from 60° C. to 125° C., preferably from 80° C. to 120° ° C., more preferably from 90° C. to 115° C. Active heating of the heating plate for the present method was found to accelerate the industrial process of manufacturing preformed pizza crusts. The process can be run much faster and the dough disks readily detach much better from the heating plate without sticking to that plate, than when the heating plate is not actively heated.

In another embodiment of the present invention, the flat surface, onto which the dough ball is placed in the method of the present invention, is heated. This advantageously allows to already start to pre-bake the dough crust during its processing and thereafter also to better detach it again from the flat surface after the pressing process is terminated. Preferably, the flat surface is heated to a temperature of at least 120° ° C., preferably of at least 160° C., more preferably at least 180° C.

The preformed pizza crust will then be baked. The baking step does not have to fully bake the pizza crust. It is sufficient, if the baking step results in a prebaked pizza crust. For example, the baking of the preformed pizza crust may be carried out at and oven temperature of least 180° C. for at least 180 seconds, at least 220° ° C. for at least 120 seconds, or at least 250° C. for at least 45 seconds.

In the next step, the lye is applied to at least a part of the baked preformed pizza crust. For example, thy lye may be sprayed onto the pizza crust. If the lye is only to be applied to certain parts of the pizza crust, for example, for certain patterns, messages or logos precision spraying may be used. Alternatively, a template may be used that protects the parts of the pizza crust, that should not be sprayed with lye.

However, as the dyes used for spraying require a relatively high degree of maintenance, it may be preferred if the lye is applied by alternative methods. A person skilled in the art will be able to devise an appropriate method. The inventors have obtained very good results with a waterfall application of the lye. Also here, areas of the pizza crust that should not be covered with lye may be protected, for example by means of a template. Hence, in one embodiment of the present invention, the application of the lye is carried out by a lye waterfall application.

A person skilled in the art will know how to best apply the toppings to the pizza crust. It may be preferred to first add the tomato-based sauce, then to add the cheese and then to add all other toppings. Optionally, the further toppings may be covered with a further layer of cheese to ensure a cheesy crust on top of the pizza. It may also be prepared to first add a layer of cheese and then to add the tomato-based sauce, before all further toppings are added. The idea here is that the melting first layer of cheese will protect the pizza crust from the water in the tomato-based sauce, which might cause the crust to become soggy. However, the traditional way to make pizza is to first add the tomato sauce, then to add the cheese and then to add all further toppings including an optional final layer of cheese. Hence, in one embodiment of the present invention applying the toppings comprises a first step of applying a sauce to the top of the baked crust and a second step where further toppings are applied on top of the sauce.

Finally, the process in accordance with the present invention may further comprise the steps of freezing or chilling the prepared pizza and packaging the frozen or chilled prepared pizza.

Those skilled in the art will understand that they can freely combine all features of the present invention disclosed herein. In particular, features described for the product of the present invention may be combined with the process of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

### Example 1: Lye Application Before or after Pre-Baking

Results showed that applying the lye post pre-bake application provides for a transformation at the final baking step, which typically takes place in the home of the consumer.

Application of the lye before pre-baking did not result in a color change in the oven during final baking. Instead, there was color change during pre-baking.

| | | | | Transformation |
|---|---|---|---|---|
| | Finished | | | at the final |
| Sample | color | Taste | Texture | baking step |
| Lye applied before | Achieved | Achieved | Achieved | Not Achieved |
| pre-baking | | | | |
| Lye applied after | Achieved | Achieved | Achieved | Achieved |
| pre-baking | | | | |

### Example 2: Test of Different Lyes Including Baking Soda (Sodium Bicarbonate) Lye

These trials were to test the use of different lyes including a baking soda (sodium bicarbonate) solution. The testing included using a baking soda solution at 10% solution and 25% solution, and heating these to a boil before applying. The trials also included not boiling the boiling the solution before applying it Product flavor, texture, and visual color was not comparable to using sodium hydroxide-based lye. Flavor, color and texture were all negatively impacted when using baking soda.

Color was only slightly darker from raw crust and did not fully achieve the darker color as expected for a pretzel. For the flavor, there was not the flavor of a pretzel achieved. The baking soda solutions so did not deliver fully on a crispy crunchy texture of a pretzel.

| Sample | Flavor | Color | Texture |
|---|---|---|---|
| 10% Baking Soda Solution | Not fully | Not fully | Not fully |
| | achieved | achieved | achieved |
| 25% Baking Soda Solution | Not fully | Not fully | Not fully |
| | achieved | achieved | achieved |
| 10% Baking Soda Solution | Not fully | Not fully | Not fully |
| | achieved | achieved | achieved |
| 25% Baking Soda Solution | Not fully | Not fully | Not fully |
| | achieved | achieved | achieved |
| 4% Sodium Hydroxide Solution | Achieved | Achieved | Achieved |
| No Boiling | | | |

### Example 3: Test Type of Sauce with Lye Solution Application

Trials were conducted to determine if sauces would react negatively with the sodium hydroxide-based lye solution. The lye solution was applied liberally to the pizza crust base, followed immediately by a tomato-based sauce or a dairy based sauce. The results showed no negative impact on the tomato sauce or on the cheese sauce (see FIG. 3). The inventors conclude that the application of raw lye and the contact of raw lye with the pizza sauce, e.g., an acidic sauce such as tomato-based sauces or dairy-based sauces, is not be an issue. Accordingly, FIG. 3 shows no impact on sauce quality with lye solution.

1. A prepared pizza that is designed to be heated before consumption comprising a prebaked pizza crust, wherein the prebaked pizza crust is coated at least partially with a lye after prebaking.

2. Prepared pizza in accordance with claim 1, wherein the toppings are applied on top of the prebaked and at least partially lye-coated pizza crust.

3. Prepared pizza in accordance with claim 1, wherein the lye is a sodium hydroxide solution.

4. Prepared pizza in accordance with claim 1, wherein the lye is applied to the rim of the pizza, but not to the rest of the pizza crust which is covered by toppings.

5. Prepared pizza in accordance with claim 1, wherein coarse salt is applied to the rim of the prebaked pizza crust on top of the lye coating before subjecting the pizza to the heating step before consumption.

6. (canceled)

7. Prepared pizza in accordance with claim 1, wherein the pizza crust is made from a dough comprising about 55-70 weight-% flour, water, about 1 to 3 weight-% salt, and about 0.05 to 2.0% weight-% yeast.

8. Prepared pizza in accordance with claim 1, wherein the prepared pizza is frozen and packaged.

9. Process for making a prepared pizza comprising the steps of:
preparing a dough by mixing the dough ingredients,
forming the dough into at least one dough ball,
proofing the at least one dough ball,
pressing a dough ball into the shape of a preformed pizza crust,
baking the preformed pizza crust,
applying lye to at least a part of the top of the baked pizza crust, and applying the toppings on top of the baked pizza crust to which the lye was at least partially applied.

10. Process in accordance with claim 9, wherein the proofing is carried out at a temperature in the range of about 18° C. to 40° C., for a time in the range of about 30 minutes to 24 hours.

11. Process in accordance with claim 9, wherein the pressing is carried out with a heated press operating at a temperature in the range of about 25° ° C. to 220° C.

12. Process in accordance with claim 9, wherein the baking of the preformed pizza crust is carried out at an oven temperature at least 250° C. for at least 45 seconds.

13. Process in accordance with claim 9, wherein the application of the lye is carried out by a lye waterfall application.

14. Process in accordance with claim 9, wherein applying the toppings comprises a first step of applying a sauce to the top of the baked crust and a second step where further toppings are applied on top of the sauce.

15. Process in accordance with claim 9, further comprising the steps of freezing or chilling the prepared pizza and packaging the frozen or chilled prepared pizza.
